(19) United States
(12) Patent Application Publication
(10) Pub. No.: US 2007/0119429 A1
(43) Pub. Date: May 31, 2007

(54) Vehicle working fluids cooling system

(76) Inventor: Brian J. Jacquay, New Haven, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/288,602

(22) Filed: Nov. 29, 2005

(51) Int. Cl. F02G 5/00; F16H 57/04

(52) U.S. Cl. 123/557; 476/14

(57) ABSTRACT

Vehicle oil, particularly transmission hydraulic fluid, is cooled by circulating the oil from the working component to a heat exchanger submerged in the fuel tank.

### BACKGROUND OF THE INVENTION

1. Technical Field

The invention relates to cooling of vehicle working fluids such as transmission fluid.

2. Description of the Problem

The oils used for vehicle hydraulic systems, such as drive train components, and for vehicle engines break down when subjected to sustained overheating. Oil coolers are frequently required for heavy duty vehicles to keep oil temperature within limits. Such cooling systems are known for power steering and transmission hydraulic fluid circuits as well as for engine oil systems. Oil coolers of various types have typically relied on direct air cooling, typically accomplished by positioning an oil cooler in line with an engine coolant radiator. However, air cooling is not the most effective method, and positioning an oil radiator directly behind the engine coolant radiator detracts from the performance of the engine radiator and adds heat to air entering the engine compartment. It is also known to use engine coolant to cool transmission fluid, though this arrangement adds to the load on the engine cooling system. Both of these solutions add the overarching problem of removing heat from the engine compartment.

### SUMMARY OF THE INVENTION

According to the invention there is provided an oil cooling system. The oil cooling system utilizes a side mounted truck fuel tank in which a heat exchanger is installed. The heat exchanger is located low in the fuel tank to remain submerged in the liquid fuel. Oil is circulated through the heat exchanger from an inlet to the heat exchanger to an outlet. The oil circulates from a vehicle component, such as the transmission, and is returned to the component from the outlet from the heat exchanger. Hoses or other conduits serve to deliver fluid to and from the heat exchanger.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a side elevation of a truck equipped with a side mounted saddle tank.

FIG. 2 is a perspective view of the relative positions of a vehicle transmission and the saddle tank.

FIG. 3 is a cut open of a saddle with a heat exchanger installed in the bottom thereof.

### DETAILED DESCRIPTION OF THE INVENTION

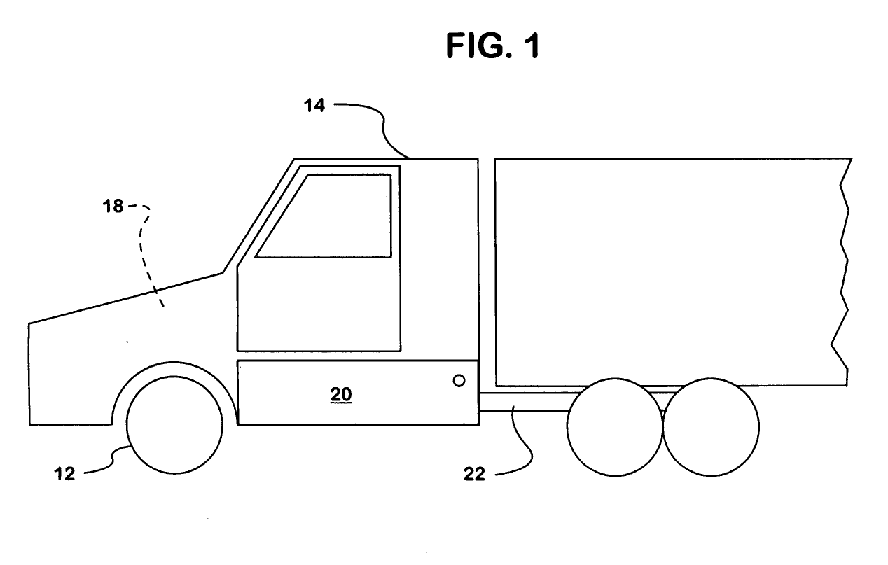

Referring now to the figures and in particular to FIG. 1, a truck 14 equipped with a fuel tank 20 adapted for transmission fluid cooling is illustrated. Truck 14 is equipped with wheels 12 and a diesel engine (not shown) located in an engine compartment 18. Fuel tanks 20 are saddle type, mounted along the sides of the vehicle where they are attached to vehicle side frame rails 22. Fuel tanks 20 are cylindrical, mounted partially extending into the vehicle slipstream and outside the heat reservoir associated with engine compartment 18.

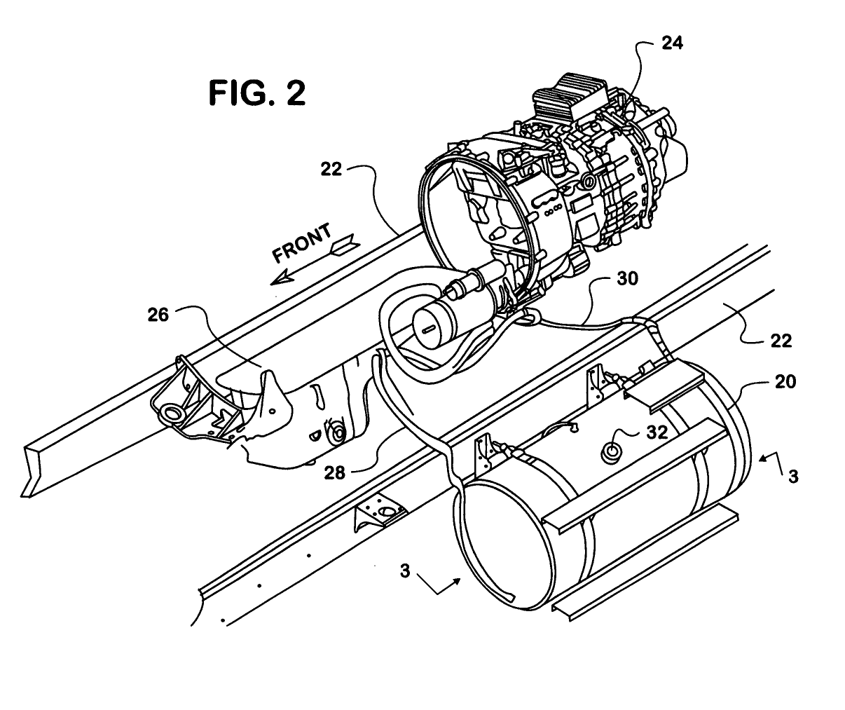

Referring now to FIG. 2, connection of a vehicle transmission housing 24 to the left side fuel tank 20 is illustrated. Transmission housing 24 is located between frame rails 22 directly behind the diesel engine for connection to the engine crankshaft. In this location the transmission housing 24 is exposed to heat transfer from the engine compartment. An engine crankcase 26 installed directly below the diesel engine and directly forward from the transmission housing 24 is also shown. The transmission within transmission housing 24 utilizes an oil or transmission fluid as a working fluid. In operation the transmission fluid is exposed to substantial heating during circulation through the transmission. To allow cooling of the oil the oil circulation circuit includes an outlet hose 28 and a return hose 30 from and to the transmission housing 24 for transfer of transmission fluid to and from a heat exchanger 36. The present invention provides that the heat exchanger 36 be installed submerged in fuel in one of side mounted fuel tanks 20. Outlet hose 28 is illustrated connected to the front face of fuel tank 20 and return hose 30 is connected to the trailing face of fuel tank 20 for delivering transmission fluid to and taking it from the heat exchanger. Fuel tank 30 is equipped with a fuel vent 32.

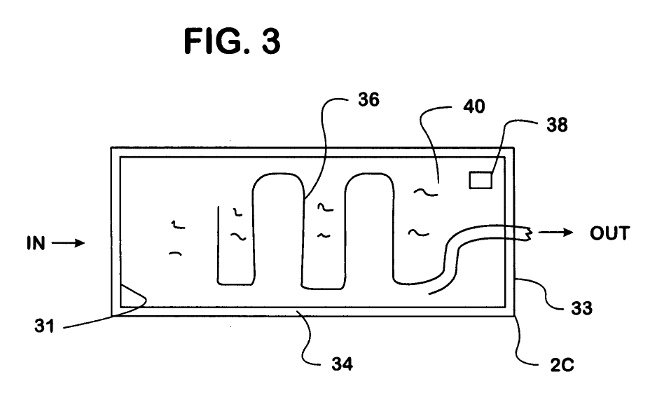

Referring to FIG. 3, a cutaway section view of the bottom of fuel tank 30, taken along section lines 3 in FIG. 2 is illustrated. Heat exchanger 36 is positioned in the bottom portion of fuel tank 30 where it remains submerged in fuel 40 even when only a fraction of the tanks capacity is taken up by fuel. Heat exchanger 36 extends from front wall 31 to back wall 33, connecting at its ends to the outlet hose 28 and return hose 30, respectively. Heat exchanger 36 may be a straight through pipe, or it may be serpentine in shape, as shown, to promote the transfer of heat. Heat exchanger 36 is preferably made of a good heat conducting material, such as copper. Heat is thereby transmitted to the fuel 40 and from the fuel through tank walls 34 to the ambient atmosphere. A fuel level sensor 38 is preferably included in the tank for provided indication of fuel levels approaching the upper edge of the heat exchanger 36. This is useful in preventing so much fuel being drained from the tank 20 so as to expose the heat exchanger 36 and compromising heat transfer. Circulation of fuel 40 within the tank 20 promotes transfer of heat to the tank wall 34 where it is radiated to the environment.

Because of the advantages of using a liquid over air to remove heat from transmission fluid, the heat exchange mechanism can be made simple, and radiating vanes may not be necessary.

While the invention is shown in only two of its forms, it is not thus limited but is susceptible to various changes and modifications without departing from the spirit and scope of the invention.

What is claimed is:

1. A motor vehicle comprising:
a fuel tank;
a heat exchanger located within the fuel tank and having an inlet and an outlet on the exterior of the fuel tank; and
an oil circuit including first and second transfer hoses, the first transfer hose being connected to the inlet to the heat exchanger and the second transfer hose being connected to the outlet from the heat exchanger.

2. A motor vehicle according to claim 1, further comprising:
the oil circuit including the vehicle transmission with transmission hydraulic fluid circulating in the oil circuit.

3. A motor vehicle according to claim 2, further comprising:
a fuel level sensor in the fuel tank providing warning if the fuel level falls to a level exposing the heat exchanger.

4. Apparatus comprising:
a vehicle transmission using hydraulic fluid;
a heat exchanger for the hydraulic fluid;
transfer hoses connecting the vehicle transmission to the heat exchanger for moving hydraulic fluid from the transmission to the heat exchanger;
a tank containing a liquid;
the heat exchanger being submerged in the liquid contained in the tank with heat being released to the environment through the tank.

5. Apparatus according to claim 4, wherein the tank is a fuel tank and the liquid is fuel.

6. A cooling system for transmission fluid comprising:
a fuel tank;
a heat exchanger located in the fuel tank; and
circulating hoses delivering transmission fluid to the heat exchanger and carrying it from the heat exchanger.
